(19) United States
(12) Patent Application Publication
(10) Pub. No.: US 2018/0209839 A1
(43) Pub. Date: Jul. 26, 2018

(54) METHOD AND DETECTION SYSTEM FOR DETECTING SELF-EXCITED VIBRATIONS

(71) Applicant: SIEMENS AKTIENGESELLSCHAFT, München (DE)

(72) Inventors: DAVID BITTEROLF, Erlangen (DE); JOCHEN BRETSCHNEIDER, Esslingen (DE); PHILIPP SIEGEL, ZWICKAU (DE)

(73) Assignee: SIEMENS AKTIENGESELLSCHAFT, München (DE)

(21) Appl. No.: 15/745,349

(22) PCT Filed: Jun. 16, 2016
(86) PCT No.: PCT/EP2016/063906

§ 371 Date: Jan. 16, 2018

(30) Foreign Application Priority Data
Jul. 17, 2015 (EP) 15177320.7

(51) Int. Cl. G01H 13/00; G01H 1/00; B23Q 17/12

(52) U.S. Cl. CPC G01H 13/00; B23Q 2717/00; B23Q 17/12; G01H 1/003

(57) ABSTRACT

In a method for detecting self-excited vibrations of a separating machine tool or of a tool of the separating machine tool or of a workpiece machined by the separating machine tool, detecting while the workpiece is machined by the separating machine tool, a measurement signal representing a physical variable; forming from the measurement signal a reference signal and a filtered filter signal; generating, with an envelope curve demodulator, from the reference signal an envelope curve reference signal and from the filtered filter signal an envelope curve filter signal; comparing the envelope curve reference signal with the envelope curve filter signal and generating at least one first comparison value defined as a ratio of a magnitude of the envelope curve reference signal and a magnitude of the envelope curve filter signal, and detecting the self-excited vibrations based on the first comparison value.

The invention relates to a method for detecting self-excited vibrations of separating machine tools, in particular cutting machine tools, and/or of the tool and/or of the work piece being machined by the machine tool. In addition the invention relates to a detection system for detection of self-excited vibrations.

With machines such as e.g. machine tools, production machines and/or with robots, vibrations created by the machining process or by a fault during a machining process occur at machine elements and/or at the tool used for machining and/or at the work piece to be machined of the machine. With machine tools in particular so called chatter vibrations occur during the process of machining away metal from the work piece, such as e.g. turning or milling, which reduce the quality of the machining process and the cutting depth that can be achieved (penetration into the material to be machined).

Chatter vibrations refer to an unstable process state of the machining process, in that a vibration and the variable forces arising therefrom are self-exciting. In machining chatter vibrations represent a limit, along with the available power of the main spindle, to the volume of material that can be machined away. Chattering adversely affects the surface quality of the machined work piece, lowers the service life of the tool and damages bearings and guides of the machine. In the extreme case this results in the tool cutter or the tool breaking.

Chattering therefore leads to waste as a consequence. Often the cause of chattering lies in the mechanical resilience of the machine structure in relation to the cutting forces. In higher frequency ranges, the resilience of the tool, of the tool holder and also of the main spindle bearing in relation to the cutting forces can lead to chattering. Various approaches are known for suppressing chatter vibrations and for stabilization of the process. On the one hand these are changing the rotational speed of the main spindle as well as the modulation of the rotational speed of the main spindle and also the reduction of the cutting depth.

A first object of the invention is to specify a method by which the vibrations that occur during a separating machining process can be detected. A second object lies in specifying a detection system by which the vibrations that occur during a separating machining process can be detected and in particular in which the inventive method can be carried out.

The object related to the method is achieved by the specification of a method for detecting self-excited vibrations of separating machine tools, in particular cutting machine tools, and/or of the tool and/or of the work piece machined by the machine tool, with the following steps:
Detecting a physical variable, in particular a measurement signal, occurring during the machining of the work piece by the machine tool,
Forming a reference signal and a filtered filter signal from the physical variable, in particular from the measurement signal,
Applying an envelope curve demodulator to the reference signal and the filtered filter signal for creating an envelope curve reference signal and an envelope curve filter signal,
Creating at least one first comparison value by comparing the envelope curve reference signal and the envelope curve filter signal,
Detecting vibrations through this first comparison value.

The object related to the detection system is achieved by the specification of a detection system for detection of self-exciting vibrations comprising a separating, in particular cutting machine tool and/or the tool used for machining and/or a work piece being machined the machine tool, wherein:
Sensors are provided for acquisition of a physical variable occurring during the machining of the work piece by the machine tool, in particular a measurement signal and/or a calculation unit for a signal relevant for the machining within a drive or a controller for creation of a physical variable, in particular a measurement signal,
A first calculation unit is provided for formation of a reference signal and a filtered filter signal from the physical variable, in particular the measurement signal,
An envelope curve demodulator is provided for creating an envelope curve reference signal and an envelope curve filter signal from the reference signal and the filtered filter signal,
A second calculation unit is provided for creating at least one comparison value by comparison of the envelope curve reference signal and the envelope curve filter signal, so that vibrations are able to be detected through this first comparison value.

For detection of chatter vibrations, first of all a physical variable, referred to below as a measurement signal, is provided, in which the said vibrations are readily able to be detected.

It has been recognized in accordance with the invention that a significant characteristic of chatter is that, for physical reasons, the frequency of chatter vibrations can never coincide with the rotational frequency of the spindle or with its harmonics.

The process stability is decided in real time on the basis of a criterion derived from the measurement signal. This criterion is generated in three steps: The application of filters to the measurement signal, the creation of the envelope curve and the creation of the variable used for evaluation. The inventive method and the detection system create a variable, which delivers a unique statement about the stability state of the machining process. Advantageously the invention does not demand any complex signal processing, such as the calculation of a Fourier Transformation (FFT) for example. An equivalent circuit diagram related to the invention advantageously consists exclusively of simple linear elements and can therefore be implemented in a very simple manner. The method and the detection system exhibit a very high level of robustness in relation to non-significant parasitic frequencies.

An unstable state is only detected when the (significant) frequency components linked to this state are dominant in the amplitude. If the amplitude of a frequency component remains smaller than the amplitude of the component corresponding to the spindle speed or its harmonics, an unstable state will not be detected.

Further advantageous measures, which can be combined with one another in any given way, in order to achieve further advantages, are listed in the subclaims.

First of all two signals, namely a reference signal and a filtered filter signal, are generated from the physical variable, i.e. here the measurement signal. Initially therefore a high pass filter is applied to the signal. The first signal created from the high pass filtered measurement signal will be referred to below as the “reference signal”. The aim here is the filtering (out) of the absolute value component from the measurement signal. I.e. a high pass filter is provided for formation of the reference signal, with which an absolute value of the measurement signal is able to be removed from the measurement signal.

In an advantageous manner the formation of a filtered filter signal from the measurement signal is undertaken by means of a filter, by which the rotational frequency of the work piece and/or of the tool, as well as their harmonics, will be filtered out of the measurement signal. The aim here is to filter all known frequency components out of the measurement signal. If necessary frequencies of known influences of external equipment, such as pumps or pneumatic systems, will also be removed for example.

In a particular embodiment the filter is embodied as a filter with equidistant zero points, in particular a filter with a finite impulse response (finite impulse response filter, FIR filter). For filtering the . . . at the rotational frequency of the work piece and/or of the tool and its multiples, a filter with equidistant zero points can be used for example. This behavior can be achieved in a very simple manner with the aid of an FIR filter. Such a behavior can be obtained for example by the formation of the average value of the unchanged input signal and of the delayed input signal with the leading sign reversed. The dead time used for the delay precisely corresponds to the period of the frequency corresponding to the first zero point.

Preferably one or more band-stop filters is/are provided in addition to the filter, which are connected upstream or downstream of the filter. I.e. the FIR filter can be supplemented by one or more band-stop filters, in order to filter out further parasitic frequencies from external equipment.

In a preferred embodiment the envelope curve demodulator has a rectifier or an absolute value generator and a low pass filter connected downstream of the rectifier. The envelope curve can then be formed in a very wide variety of ways. For example the envelope curve can be formed by rectification or absolute value generation followed by smoothing, or by low pass filtering of the signal.

In a preferred exemplary embodiment the first comparison value is embodied as a ratio value, which is given by the ratio of the amount of the envelope curve reference signal to the amount of the envelope curve filter signal. This means that the ratio of the two envelope curves is used to make a statement about the state of the process.

Vibrations are absent in particular when the amount of the envelope curve reference signal is significantly higher than the amount of the envelope curve filter signal, so that the ratio value is above one, in particular well above one. If no vibrations, in particular chatter vibrations, are occurring, the dominant frequency components are those that will be filtered out with the aid of e.g. the FIR filter and lie at the rotational frequency of the main spindle and its harmonics. In this case the amount of the envelope curve of the filtered signal lies far lower than the amount of the envelope curve of the reference signal. The ratio of the two envelope curves, i.e. reference signal divided by filter signal, thus lies well above one.

By contrast, when vibrations occur that do not lie at the filtered frequencies, the amount of the envelope curve reference signal is essentially the same as the amount of the envelope curve filter signal, so that the ratio value is practically one. I.e. on occurrence of vibrations, in particular chatter vibrations, these chatter vibrations form the dominant frequency components. Since chatter vibrations by definition do not coincide with the spindle rotation frequency and its harmonics, the filtering of the rotational frequency and its harmonics has little influence on the envelope curve. In this case the amounts of the two envelope curves are practically identical and the ratio lies at one.

Preferably a reference value, which is given by a comparison of the amount of the envelope curve filter signal with a predetermined reference value, is embodied as a second comparison value. The amount of the envelope curve filter signal is used in order to detect whether the tool is in engagement or not. I.e. that it can be derived from the amplitude of the envelope curve of the filtered signal whether the tool is in engagement or not. For this the amount of the envelope curve is compared with a predetermined threshold value.

In the preferred embodiment the vibrations are chatter vibrations.

In the preferred embodiment a machine tool comprising at least one main spindle is provided. The sound pressure, in particular the sound pressure within a working space enclosing the machine tool, can be used as the physical variable or as measurement signals. In addition or as an alternative the acceleration at a given point of the working machine, i.e. the acceleration at a given point of the machine structure, can be used. Also any given drive signal such as e.g. the torque-generating actual current or speed value can be used.

Further features, characteristics and advantages of the present invention emerge from the description given below, which refers to the enclosed figures. In these figures, in schematic diagrams:

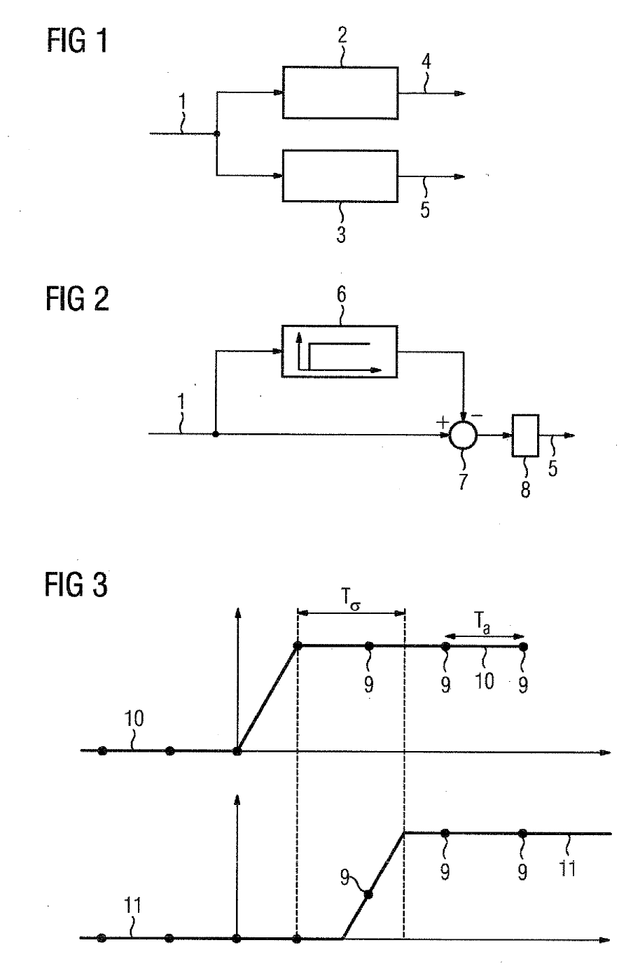

FIG. 1 shows generation of the variables necessary for the method and detection system,

FIG. 2 shows a block diagram of the implementation of the FIR filter,

FIG. 3 shows an example for the transmission behavior of a broken dead time,

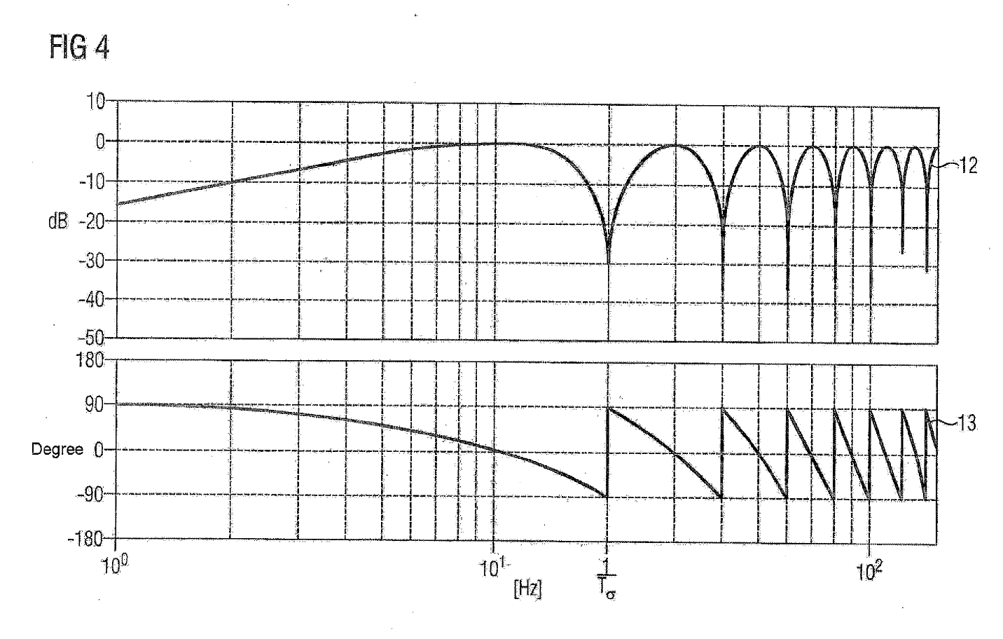

FIG. 4 shows the transmission behavior of the FIR filter with a basic frequency of 20 Hz,

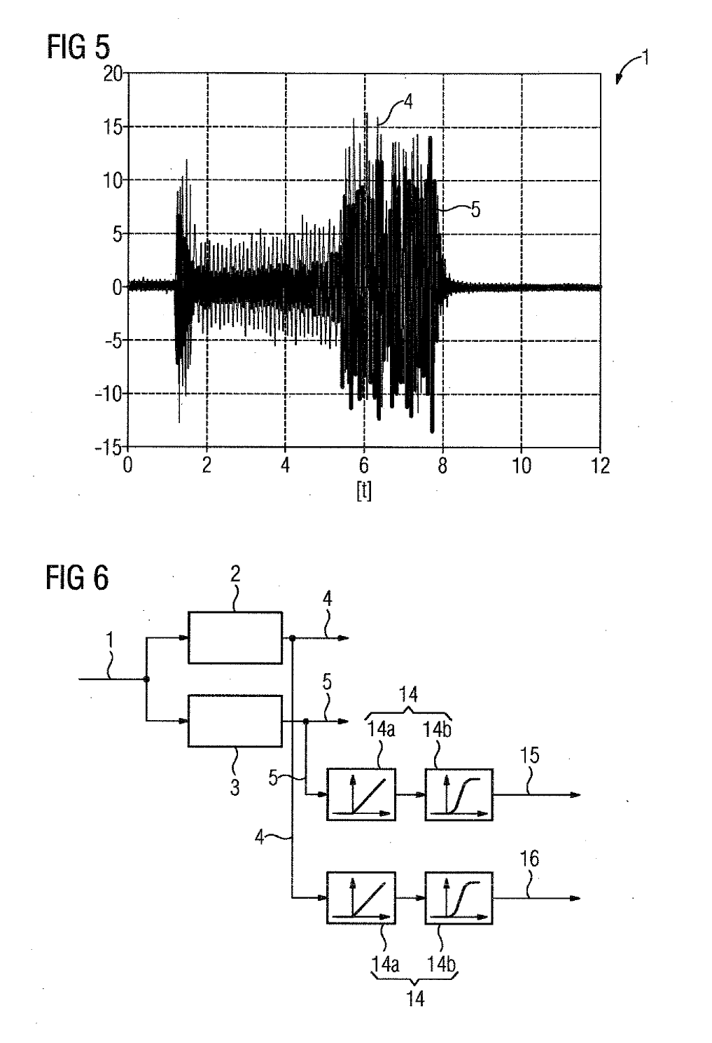

FIG. 5 shows the reference signal and the filtered signal,

FIG. 6 shows a block diagram for the filtering of the measurement signal and the creation of the envelope curves,

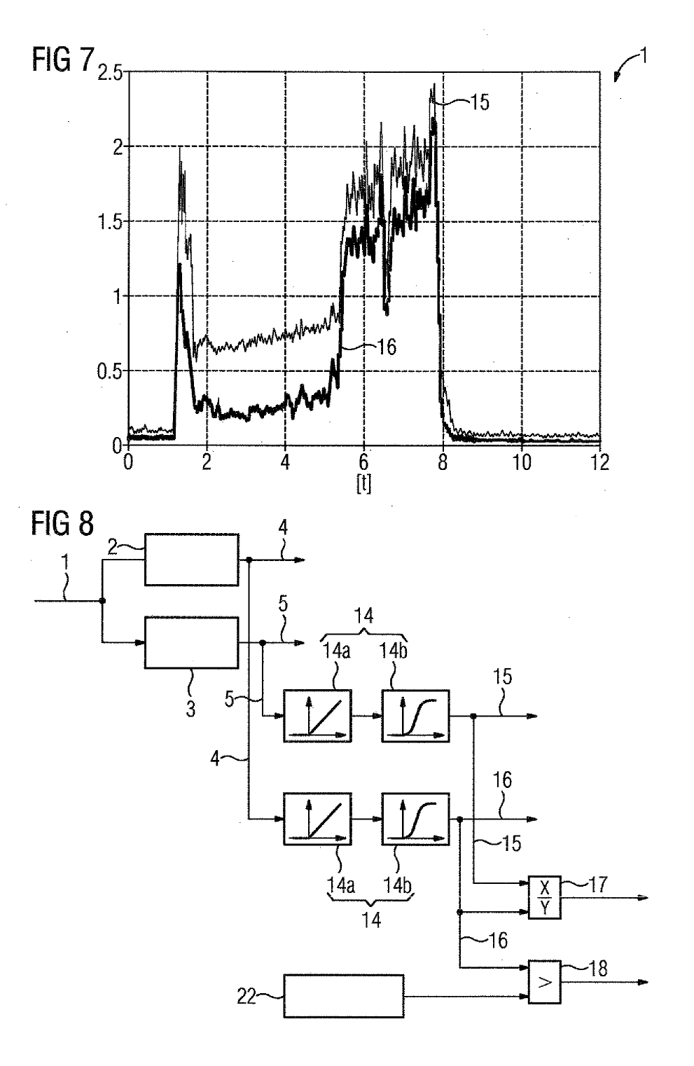

FIG. 7 shows envelope curves of the reference signal and the filtered signal,

FIG. 8 shows a block diagram of the method,

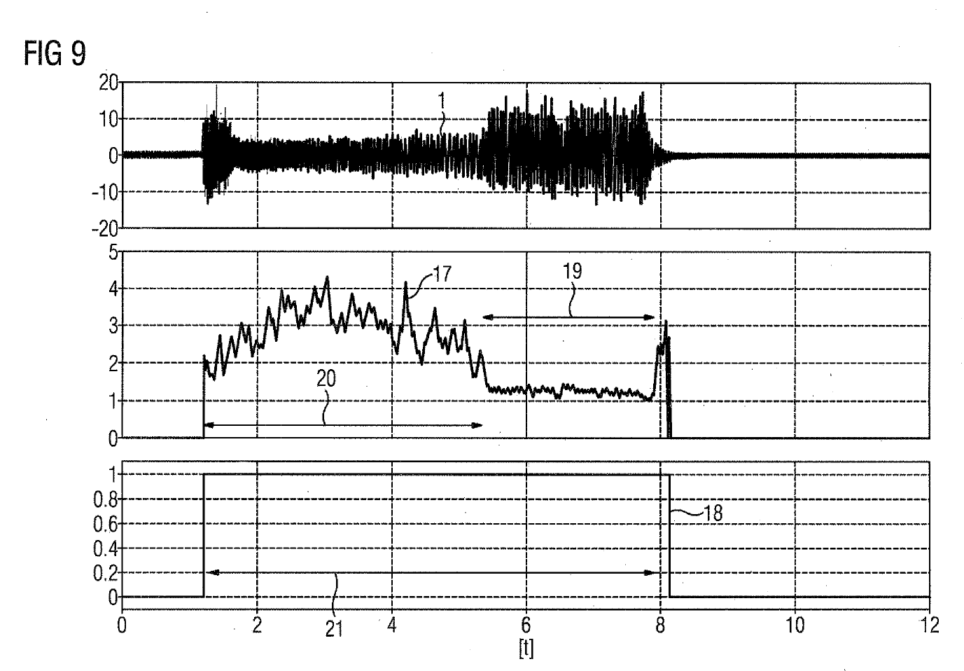

FIG. 9 shows the application of the method and of the detection system to a measurement signal.

Although the invention has been illustrated and explained in greater detail by the preferred exemplary embodiment, the invention is not restricted by the disclosed examples. Variations herefrom can be derived by the person skilled in the art, without departing from the scope of protection of the invention, as will be defined by the claims given below.

The invention is explained using the example of a machine tool with at least one spindle for a cutting process. Chatter vibrations represent a major problem during machining. It should be noted that the invention is not restricted to this example however.

First of all, for detection of chatter vibrations, the measurement signal 1 is to be determined, in which the said vibrations are easy to detect. Different signals can be used for the inventive method and the inventive detection system, such as for example; the sound pressure e.g. within the working space of the machine, the acceleration at a given point of the machine structure or a given drive signal such as e.g. the torque-generating actual current or speed value of the spindle or of a given axis. The measurement signals 1 can be detected by one or more suitable sensors.

In accordance with the invention a method and a detection system will now be described for how a criterion, i.e. a number of steps for the occurrence of chatter vibrations, will be derived from this signal. The process stability will therefore be decided in real, time in accordance with the invention on the basis of a number of steps derived from a suitable measurement signal 1; namely the application of filters to the measurement signal 1, the creation of an envelope curve and the creation of the variable used for evaluation.

FIG. 1 first shows the filtering. In this process two signals are generated from the measurement signal 1: a reference signal 4 and a filtered filter signal 5. The reference signal 4′ is created from the high pass filtered measurement signal 1. A discrete filter of the second order can be used as the high pass filter 2 for example. The aim of this branch is the filtering of the direct component out of the measurement signal 1. Any given high pass filter 2 can be used for this. The second signal is produced from the measurement signal 1 after the frequency components lying at the spindle rotational speed and its harmonics have been removed from it. This signal will be referred to below as the “filtered filter signal 5”. The aim here is to filter all known frequency components out of the measurement signal 1. If necessary frequencies of known influences of external equipment, such as from pumps of from pneumatic systems, will be removed.

For filtering the frequency components lying near the spindle frequency and its multiples, a filter with equidistant zero points can be used for example. This behavior can be achieved in a simple manner with the aid of a FIR filter 3.

The principle of the FIR filter 3 used here is shown in FIG. 2. In this principle the measurement signal is delayed by a delay element 6, the broken dead time Tσ (FIG. 3). If a given signal is “mixed” with a delayed copy of the same (additive, overlaid) a comb-filtered signal is produced. Frequencies of which the periodicity or multiples thereof correspond to the delay time, cancel each other out (destructive interference), while double the signal amplitude (constructive interference) is obtained for the frequencies lying precisely between them.

With the broken dead time Tσ (FIG. 3) a given input signal, e.g. the measurement signal 1, is delayed by a time that is not a multiple of the sampling time Tσ. Here the dead time Tσ (FIG. 3), with which the measurement signal 1 is delayed, corresponds to the time for one revolution of the spindle, i.e. the reciprocal of the spindle speed. This will subsequently be subtracted by means of a subtractor 7 from the continuous measurement signal 1. If however a sinusoidal signal is used, with a frequency that is precisely 1.5× the spindle speed for example, then after the subtractor 7, a signal is obtained with double the amplitude. In order to avoid that, the signal obtained after the subtractor 7 has a factorizer 8 applied to it.

FIG. 3 shows, in a simplified example of a sampled rectangular signal as input signal 10, the transmission behavior of a broken dead time Tσ by means of a delay element 6 (FIG. 2). In this case an input signal 10 at different sampling points 9 between a sampling time Tσ over a time t is shown in the upper part of FIG. 3. The output signal 11 produced from the input signal 10 delayed with the dead time Tσ is shown in the lower part of FIG. 3.

FIG. 4 shows the transmission behavior with equidistant zero points with the basic frequency 20 Hz of a FIR filter 3 (FIG. 1) in a Bode diagram. A typical basic frequency of 20 Hz has been selected for the parameterization, which corresponds to a dead time Tσ of 50 ms. The first, non-static (at frequency 0 Hz) zero point of the filter at the basic frequency 20 Hz and all multiples, including the harmonics of the order 0, i.e. the direct component can be seen.

FIG. 5 now shows the reference signal 4, which was created by means of a high pass filter 2 (FIG. 1), and also the filter signal 5 filtered with the FIR filter 3 (FIG. 1), out of which the frequency components lying close to the spindle frequency and their multiples have been filtered. In this case the sound pressure has been used as the measurement signal (FIG. 1). If necessary the FIR filter can be supplemented with one or more band-stop filters, in order to filter further discrete parasitic frequencies out of external equipment.

Subsequently an envelope curve demodulator 14 is applied to the reference signal 4 and the filtered filter signal 5 to create an envelope curve reference signal 15 and an envelope curve filter signal 16. FIG. 6 shows the block diagram for the filtering of the measurement signal 1 and the creation of the envelope curves.

The envelope curves can be formed in any given way by the envelope curve demodulator 14 in a wide variety of ways. For example the envelope curve can be formed by rectification 14a or absolute value formation (not shown) followed by smoothing 14b or low pass filtering of the filtered filter signal 5 or of the reference signal 4. I.e. for forming the envelope curves there is a rectification 14a or absolute value formation (not shown) of the reference signal 4 and of the filtered filter signal 5 with subsequent smoothing by a low pass filter 14b.

FIG. 7 shows the envelope curves of the reference signal 4, i.e. the envelope curve reference signal 15 and of the filtered filter signal 5, i.e. of the envelope curve filter signal 16 using the example from FIG. 5. Here the sound pressure is again used as the measurement signal 1 (FIG. 1).

The ratio of the two envelope curves, i.e. of the envelope curve reference signal 15 to the envelope curve filter signal 16, is used to make a statement about the state of the process. To do this a first comparison value is embodied as a ratio value 17, which is given by the ratio of the amount of the envelope curve reference signal 15 and of the envelope curve filter signal 16, FIG. 8. Two cases can occur here:

In the first case no chatter vibrations occur. The dominant frequency components are those that will be filtered out with the aid of the FIR filter 3 and lie at the rotational frequency of the main spindle and its harmonics. In this case the amount of the envelope curve filter signal 16 of the filtered filter signal lies significantly lower than the amount of the envelope curve reference signal 15 of the reference signal 4. The ratio of the two envelope curves thus lies far above 1.

In the second case chatter vibrations occur. Here the chatter vibrations form the dominant frequency components and the filtering of the rotation frequency and of its harmonics has little influence on the envelope curves. In this case the amounts of the two envelope curves are practically identical and the ratio lies at one.

In addition a second comparison value will be formed as a reference value 18, which is given by a comparison of the amount of the envelope curve filter signal 16 with a predetermined threshold value 22. In this way it can be derived from the amplitude of the envelope curve of the filtered filter signal 3 whether the tool is engaging or not. The amount of the envelope curve will therefore be used to detect whether the tool is engaged or not. For this the amount of the envelope curve will be compared with a predefined threshold value 22.

FIG. 9 shows the application of the method and of the detection system to the measurement signal 1 (sound pressure). Here the measurement signal 1 is shown unfalsified in the upper section of the figure. In the middle section the comparison value 17 is shown. It can be seen here that there is no chattering or chatter vibrations in time section 20, chatter vibrations are present in time section 19. In the lower section the reference value 19 can be seen. In time section 21 the tool is engaged.

1.-18. (canceled)

19. A method for detecting self-excited vibrations of a separating machine tool or of a tool of the separating machine tool or of a workpiece machined by the separating machine tool, comprising:
while the workpiece is machined by the separating machine tool, detecting a measurement signal representing a physical variable;
forming from the measurement signal a reference signal and a filtered filter signal;
generating, with an envelope curve demodulator, from the reference signal an envelope curve reference signal and from the filtered filter signal an envelope curve filter signal;
comparing the envelope curve reference signal with the envelope curve filter signal and generating at least one first comparison value defined as a ratio of a magnitude of the envelope curve reference signal and a magnitude of the envelope curve filter signal, and
detecting the self-excited vibrations based on the first comparison value.

20. The method of claim 19, wherein the separating machine tool is a metal-cutting machine tool.

21. The method of claim 19, wherein in absence of the self-excited vibrations, the ratio value is greater than one.

22. The method of claim 19, wherein, when the self-excited vibrations occur, the ratio value is substantially equal to one.

23. The method of claim 19, wherein the reference signal is a high-pass-filtered signal generated by removing a constant component from the measurement signal.

24. The method of claim 19, further comprising
determining known frequency components of the separating machine tool, the tool or the workpiece in absence of a machining operation, and
forming the filtered filter signal by filtering out of the measurement signal the known frequency components.

25. The method of claim 24, wherein the known frequencies comprise frequencies coinciding with a rotational frequency of the tool or workpiece and harmonics thereof.

26. A detection system for detecting self-excited vibrations occurring in a separating machine tool or in a machining tool of the separating machine tool or in a workpiece machined by the separating machine tool, or a combination thereof, the system comprising:
at least one sensor acquiring a measurement signal representing a physical variable, while the workpiece is machined by the separating machine tool, or a calculation unit for a signal relevant for processing within a drive or a controller for creating a measurement signal representing a physical variable,
a first calculation unit configured to form from the measurement signal a reference signal and a filtered filter signal,
an envelope curve demodulator configured to generate from the reference signal an envelope curve reference signal and from the filtered filter signal an envelope curve filter signal,
a second calculation unit configured to form at least one first comparison value defined as a ratio value of a magnitude of the envelope curve reference signal and a magnitude of the envelope curve filter signal, with the first comparison value representing a measure of the self-excited vibrations.

27. The detection system of claim 26, further comprising a high-pass filter configured to form the reference signal by removing a constant component from the measurement signal.

28. The detection system of claim 26, further comprising a filter configured to form the filtered filter signal by filtering out of the measurement signal known process-related frequency components of the separating machine tool, the tool or the workpiece.

29. The detection system of claim 28, wherein the known process-related frequency components comprise frequencies coinciding with or proportional to a rotational frequency of the tool or of the workpiece and harmonics thereof.

30. The detection system of claim 28, wherein the filter has a filter characteristic with equidistant zero points.

31. The detection system of claim 28, wherein the filter is a finite impulse response filter (FIR filter).

32. The detection system of claim 28, further comprising one or more band-stop filters, which are connected upstream or downstream of the filter.

33. The detection system of claim 26, wherein the envelope curve demodulator comprises a rectifier and a low pass filter connected downstream of the rectifier.

34. The detection system of claim 26, wherein the envelope curve demodulator comprises an absolute value generator and a low pass filter connected downstream of the absolute value generator.

35. The detection system of claim 26, wherein in absence of the self-excited vibrations, the ratio value is significantly greater than one.

36. The detection system of claim 26, wherein, when the self-excited vibrations occur, the ratio value is substantially equal to one.

37. The detection system of claim 26, wherein the second calculation unit is configured to form a second comparison value embodied as a reference value, which is derived from a comparison of the magnitude of the envelope curve filter signal with a predetermined threshold value, with the second comparison value indicating whether the tool is in engagement with the machined workpiece.

38. The detection system of claim 37, wherein the predetermined threshold value is a parameterizable threshold value.

39. The detection system of claim 26, wherein the vibrations are chatter vibrations.

40. The detection system of claim 26, wherein the separating machine tool comprises at least one main spindle and the physical variable comprises at least one of sound pressure, acceleration at a given location of the separating machine tool and a drive signal.

41. The detection system of claim 40, wherein the separating machine tool is enclosed inside a work room and the sound pressure is measured inside the work room.
